(19) United States
(12) Patent Application Publication
(10) Pub. No.: US 2015/0280760 A1
(43) Pub. Date: Oct. 1, 2015

(54) METHOD AND DEVICE FOR CANCELLING A NARROW BAND INTERFERENCE IN A SINGLE CARRIER SIGNAL AND COMPUTER PROGRAM

(71) Applicant: MITSUBISHI ELECTRIC CORPORATION, Tokyo (JP)

(72) Inventor: Damien CASTELAIN, Rennes (FR)

(73) Assignee: MITSUBISHI ELECTRIC CORPORATION, Tokyo (JP)

(21) Appl. No.: 14/638,640

(22) Filed: Mar. 4, 2015

(30) Foreign Application Priority Data
Mar. 31, 2014 (EP) 14162742.2

(51) Int. Cl. H04B 1/12; H04L 25/03; H04L 25/02

(52) U.S. Cl. CPC H04B 1/12; H04L 25/0202; H04L 25/03159

(57) ABSTRACT

The present invention concerns a method for cancelling a narrow band interference in a single carrier signal, characterized in that the method comprises the steps executed by a receiver of:
receiving the single carrier signal and transforming the single carrier signal into received symbols,
transforming the received symbols from the time domain to the frequency domain into received symbols in the frequency domain,
determining a threshold based on the received symbols in the frequency domain,
truncating the amplitudes of the received symbols in the frequency domain at the determined threshold,
performing a channel estimation based on the truncated received symbols in the frequency domain.

### BACKGROUND OF THE INVENTION

1. Field of the Invention

The present invention relates generally to a method and a device for cancelling a narrow band interference in a single carrier signal representative of received symbols.

The present invention is related to narrow band interferer cancellation in telecommunication systems based on Single Carrier modulation the demodulation of which is implemented in the frequency domain.

For example and in a non-limitative way, the present invention may be applied to Single Carrier orthogonal frequency division multiplex modulation scheme (SC-OFDM).

2. Description of the Related Art

SC-OFDM is a modulation scheme with OFDM-type multiplexing but single-carrier-like envelope. It can be implemented either in the time-domain or in the frequency-domain. In the last case, it is also called DFT-spread OFDM, or SC-FDE (Single Carrier Frequency Domain Equalisation) or SC-FDMA (Single Carrier Frequency Division Multiple Access). The frequency domain implementation is generally preferred, especially in the receiver.

### SUMMARY OF THE INVENTION

The present invention may be applied to Single Carrier Time Division Multiplex (SC-TDM) if equalization is performed in the frequency domain.

The present invention finds application into wireless cellular telecommunication networks like 3GPP/LTE uplink transmission or broadcasting system like Digital Video Broadcasting Next Generation Handheld (DVB NGH) systems and satellite communication systems.

The present invention aims at providing a method and a device which enable the cancellation of at least one narrow band interference in a single carrier signal.

To that end, the present invention concerns a method for cancelling a narrow band interference in a single carrier signal, characterized in that the method comprises the steps executed by a receiver of:
receiving the single carrier signal and transforming the single carrier signal into received symbols,
transforming the received symbols from the time domain to the frequency domain into received symbols in the frequency domain,
determining a threshold based on the received symbols in the frequency domain,
truncating the amplitudes of the received symbols in the frequency domain at the determined threshold,
performing a channel estimation based on the truncated received symbols in the frequency domain.

The present invention also concerns a device for cancelling a narrow band interference in a single carrier signal, characterized in that the device is included in a receiver and comprises:
means for receiving the single carrier signal and transforming the single carrier signal into received symbols,
means for transforming the received symbols from the time domain to the frequency domain into received symbols in the frequency domain,
means for determining a threshold based on the received symbols in the frequency domain,
means for truncating the amplitudes of the received symbols in the frequency domain at the determined threshold,
means for performing a channel estimation based on the truncated received symbols in the frequency domain.

Thus, the amount of interference in received symbols that are representative of data and/or pilot symbols is reduced, the channel estimation is improved and the overall performance of the receiver is improved.

According to a particular feature, the receiver:
estimates the frequency-dependent received powers of received symbols in the frequency domain,
determines iteratively an adaptive signal and thermal noise power from the estimated frequency dependent receive powers,
determines the threshold truncating the received symbols in the frequency domain from the adaptive signal and thermal noise power determined at the last iteration.

Thus, the threshold is determined from an estimation of the signal plus thermal noise power excluding the interference power. The threshold is determined independently of the interference power which insures to truncate interference in an efficient way without degrading the signal itself.

According to a particular feature, the adaptive signal and thermal noise power iteratively determined is determined by:
executing a first averaging of the total received powers of the received symbols in the frequency domain,
determining, at a first iteration, a threshold based on the averaged total received power,
truncating all powers of the received symbols in the frequency domain which are upper than the determined threshold at the first iteration,
executing a second averaging of the truncated powers,
correcting the second average by a correction coefficient,
determining at a following iteration a following adaptive threshold based on the corrected average,
truncating all powers which are upper than the following adaptive threshold,
executing a third averaging of the truncated powers,
correcting the third averaging by a correction coefficient,

and executing a predetermined number of times the adaptive threshold determination, the truncating, the third averaging and the correcting.

Thus, the signal plus noise level power excluding the interference power is simply determined, the correction coefficient is insuring that the signal plus noise level power is not underestimated even when no interference is present and insuring an adequate calculation of the threshold that is applied to the received symbols in the frequency domain.

According to a particular feature, at each iteration the correction coefficient is calculated assuming that the symbols the powers of which are truncated follow a complex Gaussian law.

Thus, at each iteration the power loss due to the truncation is compensated by the correction coefficient if no interference is present.

According to a particular feature, the coefficients are determined using a lookup table.

Thus, the correction coefficients are easily determined without any additional computation.

According to a particular feature, the single carrier signal is a single carrier orthogonal frequency division multiplex modulation signal.

Thus, the frequency domain implementation of the demodulation is facilitated by dedicated header or prefix.

According to a particular feature, the receiver performs a frequency dependent noise plus interference power estimation based on the received symbols transformed from the time domain to the frequency domain into received symbols in the frequency domain or based on the truncated received symbols in the frequency domain.

Thus, the equalization performance is improved.

According to a particular feature, the receiver performs a minimum mean square error equalization based on the channel estimation, based on the truncated received symbols in the frequency domain and based on the frequency dependent noise plus interference power estimates.

Thus, the equalization is optimal according to the minimum square error criterion and overall performance is improved.

According to still another aspect, the present invention concerns computer programs which can be directly loadable into a programmable device, comprising instructions or portions of code for implementing the steps of the methods according to the invention, when said computer programs are executed on a programmable device.

Since the features and advantages relating to the computer programs are the same as those set out above related to the methods and apparatus according to the invention, they will not be repeated here.

### BRIEF DESCRIPTION OF THE DRAWINGS

The characteristics of the invention will emerge more clearly from a reading of the following description of an example of embodiment, the said description being produced with reference to the accompanying drawings, among which:

FIG. 1 represents a wireless link in which the present invention is implemented;

FIG. 2 is a diagram representing the architecture of a receiver in which the present invention is implemented;

FIG. 3 discloses a block diagram of components of the wireless interface of the receiver;

FIG. 4 represents an example of a received signal with narrow band interference;

FIG. 5 discloses a block diagram of components of the adaptive threshold determination and truncation module according to the present invention;

FIG. 6 discloses an example of an algorithm executed by a destination according to the present invention.

### DETAILED DESCRIPTION OF THE INVENTION

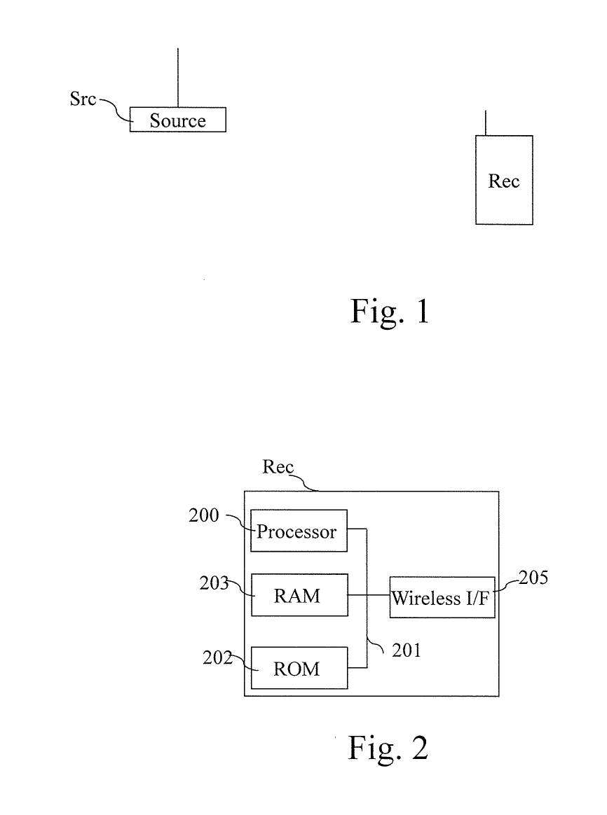

FIG. 1 represents a wireless link in which the present invention is implemented.

The present invention will be disclosed in an example in which the signals transferred by a source Src are transferred to at least one receiver Rec.

Only one receiver Rec is shown in the FIG. 1 for the sake of simplicity, but signals may be received by a more important number of receivers Rec.

The receiver Rec may be included in a fixed or mobile terminal to which data like video signals are transferred.

Data and possibly information enabling an estimate of the wireless link between a source and one receiver are transferred using single carrier modulation.

According to the invention, the receiver Rec:
transforms the received symbols from the time domain to the frequency domain into received symbols in the frequency domain,
determines a threshold based on the received symbols in the frequency domain,
truncates the amplitudes of the received symbols in the frequency domain at the determined threshold,
performs a channel estimation based on the truncated received symbols in the frequency domain.

FIG. 2 is a diagram representing the architecture of a receiver in which the present invention is implemented.

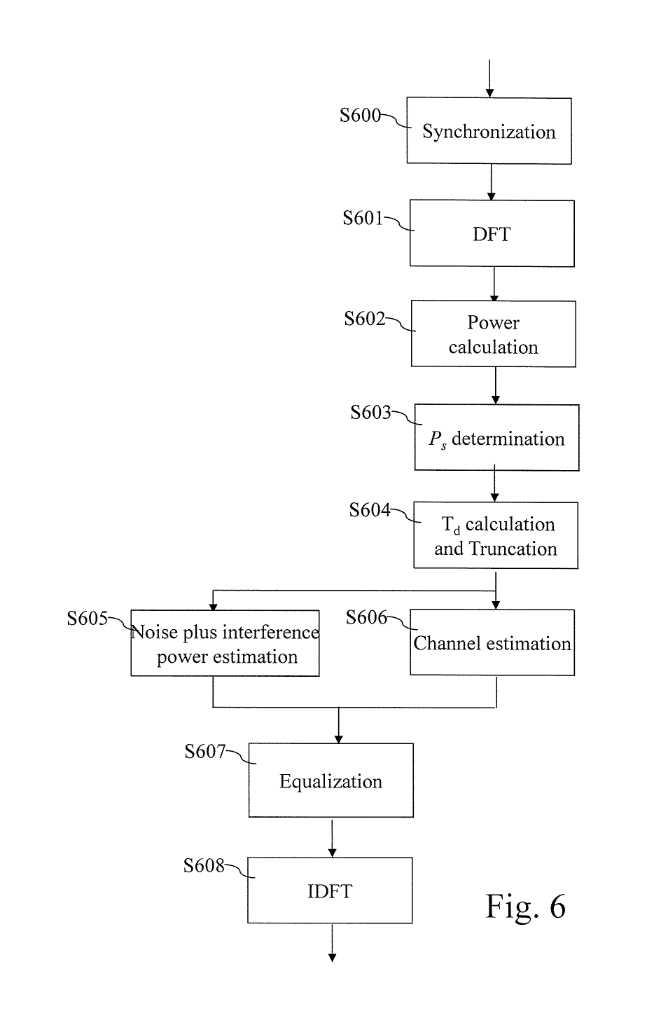

The receiver Rec has, for example, an architecture based on components connected together by a bus 201 and a processor 200 controlled by the program as disclosed in FIG. 6.

It has to be noted here that the receiver Rec may have an architecture based on dedicated integrated circuits.

The bus 201 links the processor 200 to a read only memory ROM 202, a random access memory RAM 203 and a wireless interface 205.

The memory 203 contains registers intended to receive variables and the instructions of the program related to the algorithm as disclosed in FIG. 6.

The processor 200 controls the operation of the wireless interface 205.

The read only memory 202 contains instructions of the program related to the algorithm as disclosed in FIG. 6, which are transferred, when the receiver Rec is powered on, to the random access memory 203.

Any and all steps of the algorithms described hereafter with regard to FIG. 6. may be implemented in software by execution of a set of instructions or program by a programmable computing machine, such as a PC (Personal Computer), a DSP (Digital Signal Processor) or a microcontroller; or else implemented in hardware by a machine or a dedicated component, such as an FPGA (Field-Programmable Gate Array) or an ASIC (Application-Specific Integrated Circuit).

In other words, the receiver Rec includes circuitry, or a device including circuitry, causing the receiver Rec to perform the steps of the algorithms described hereafter with regard to FIG. 6.

Such a device including circuitry causing the receiver Rec to perform the steps of the algorithm described hereafter with regard to FIG. 6 may be an external device connectable to the receiver Rec.

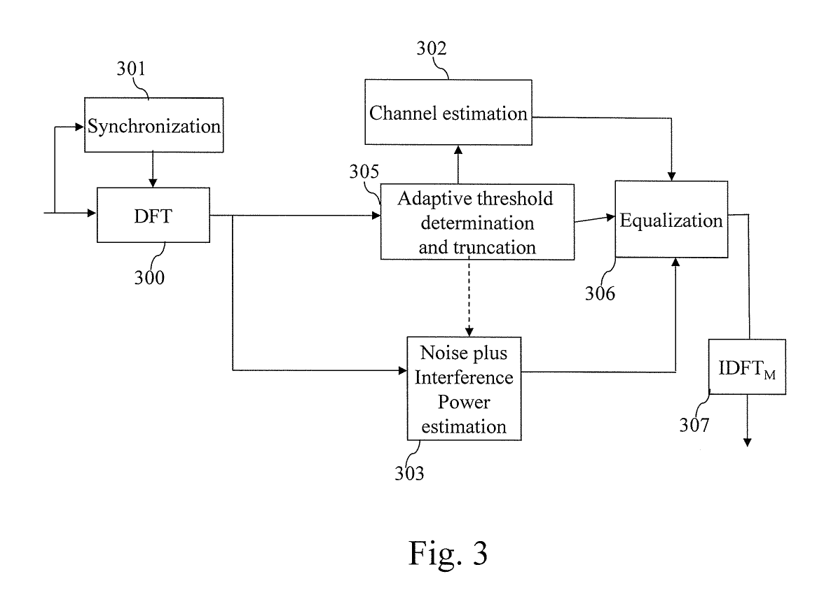

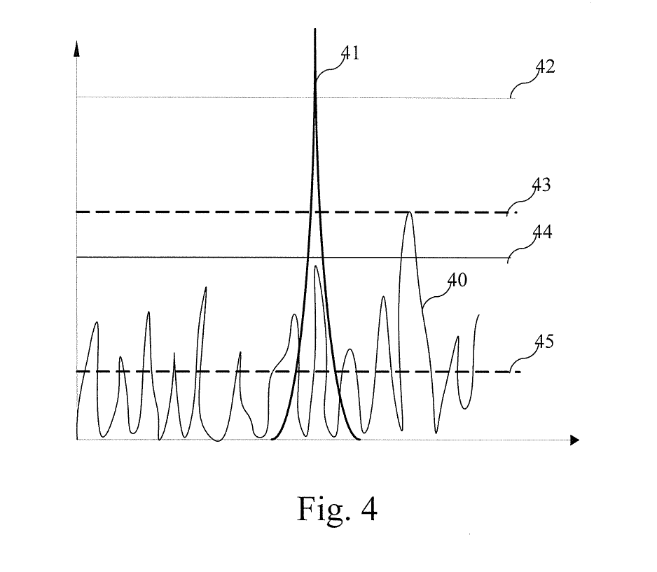

The wireless interface 205 comprises components as disclosed in FIG. 3.

FIG. 3 discloses a block diagram of components of the wireless interface of the receiver.

The wireless interface 205 comprises a synchronization module 301 which is in charge of synchronizing a DFT module 300 of the wireless interface 205 on the received symbols.

The DFT module 300 transforms the received symbols from the time domain to the frequency domain into received symbols in the frequency domain yₖ where k denotes the index of subcarrier. The received symbols are obtained by transforming the received single carrier signal into received symbols.

The received symbols in the frequency domain may be represented by:

yₖ=hₖxₖ+υₖ

Where hₖ is the channel response for carrier of index k, and where υₖ is the additive noise at the same frequency. The term υₖ is the addition of the Additive White Gaussian Noise (AWGN) noise e.g. the thermal noise and the narrow band interferer. Because of the narrow band interferer, the variance of υₖ is frequency-dependent and is denoted by σₖ².

The received symbols in the frequency domain may be provided to a frequency dependent noise plus interference power estimation module 303 and to, according to the present invention, an adaptive threshold determination and truncation module 305.

The adaptive threshold reduces the amount of narrow band interference in the received symbols which are either data or pilot symbols and then improves the channel estimation and the accuracy of the estimated data after equalization. Thus it improves the overall performance of the reception.

The output of the adaptive threshold determination and truncation module 305 is provided to an equalization module. For example the equalization module is a Minimum Mean Square Error equalization module 306 which equalizes in the frequency domain and provides samples expressed by:

$${z}_{k} = \frac{{h}_{k}^{*}}{{\vert {h}_{k} \vert}^{2} + {σ}_{k}^{2}} {y}_{k} .$$

h*ₖ denotes the conjugate of the estimated channel for carrier k.

It has to be noted here that the σₖ² may be replaced by an estimate of the mean of the additive noise variances or by a predetermined value.

The output of the adaptive threshold determination and truncation module 305 may be provided to the noise plus interference power estimation module 303. The adaptive threshold determination and truncation module 305 determines the adaptive threshold according to the invention and truncates signals which are upper than this adaptive threshold according to the invention.

According to the invention, the received symbols in the frequency domain are truncated according to the following formula:

yₖ=ρₖe^{iφ}^{ₖ} if ρ²ₖ<T_{d}

yₖ=\sqrt{T_{d}}e^{iφ}^{ₖ} if ρₖ²≧T_{d}

with i is the square root of ‘−1’ in both above mentioned formulas, where T_{d} is the threshold determined for truncating data according to the present invention, ρₖ is the frequency-dependent received amplitude of the received symbol at carrier k and ωₖ is the phase of the received symbol at carrier k.

The output σₖ² of the frequency dependent noise plus interference power estimation module 303 is provided to the equalization module 306.

The noise plus interference power estimation module 303 is for example as the one disclosed in the European patent application EP07005381.

The output of the adaptive threshold determination and truncation module 305 is provided to a channel estimation module 302 that estimates the channel responses for the carriers processed by the adaptive threshold determination and truncation module 305. The output of the channel estimation module 302 is provided to the equalization module 306.

The channel estimation is for example based and in a non limitative way on pilot symbols.

The output of the adaptive threshold determination and truncation module 305 is provided to the equalization module 306.

The output of the equalization module 306 is provided to an IDFT module 307 which may have a different size than the DFT module 300.

Classical Minimum Mean Square Error equalization process assumes a perfect knowledge of the channel. However, the channel estimation process is sensitive to the interferers. It must be noted that the interferer power can be much larger than the signal power.

An example of interferer is given in reference to the FIG. 4.

FIG. 4 represents an example of a received signal with narrow band interference.

The received signal with narrow band interference is represented in the frequency domain, i.e. once the DFT module 300 transforms the received symbols from the time domain to the frequency domain.

The horizontal axis represents the frequency and the vertical axis represents the power of signals received in the frequency bands.

The interference power 43 may be much larger than the signal and thermal noise power 45. If the interferer 41 is a pure sine, a good reception may be obtained with a signal over interference power ratio C/I of −10 dB, i.e. with an interferer ten times more powerful than the signal.

As the present invention aims to truncate the interferer 41 as much as possible, while altering as few as possible signal and thermal noise 40, if no interferer is present, no degradation should be observed.

If the receiver sets up a threshold according to the received power Pt noted 43, the threshold 42 would be rather inefficient if the interferer power is large, as the threshold would be much higher than the signal plus noise power 45.

If the signal and thermal noise power 45 called Ps is known, then a threshold T_{d} noted 44 of about Ps+4 dB provides good performance. If the receiver Rec only knows the total power Pt, in order to be sure not to degrade the signal if there is no interferer, the receiver Rec must use a threshold of about T′=Pt+4 dB noted 42. If the interferer is high, Pt is much larger than Ps, and the threshold T′ 42 is much larger than the optimum threshold T 44.

Therefore, the present invention estimates Ps prior defining the threshold.

The estimation is based on the frequency-dependent received power pₖ.

For estimating the frequency-dependent received power pₖ, the present invention may be implemented on a block basis, i.e. by using

pₖ=|yₖ|²

The present invention may be implemented on averaging basis, for example by applying a filtering between successive (in time) values of |yₖ|²:

$${p}_{k} = filtering ( {\vert {y}_{k}^{j} \vert}^{2} ) = {\sum }_{j} {a}_{j} {\vert {y}_{k}^{j} \vert}^{2}$$

Where j is the time block index, a block being a set of samples over which the block demodulation, like DFT, processing in the frequency domain, IDFT is applied.

The aⱼ values are the coefficients of the smoothing time filter.

Knowing the pₖ values, the estimation of Pₛ is based on the following principle: the signal plus thermal noise has a Gaussian-like statistics in the frequency domain, while the interferers are ‘peaks’, and therefore much more sensitive to a threshold.

The estimation may be performed in an iterative way as follows:

A first estimate of the signal and thermal noise power Pₛ is equal to the total received power Pₜ:

$${P}_{0} = {P}_{t} = \frac{1}{M} {\sum }_{k} {p}_{k} .$$

Where M is the size of the IDFT performed by the IDFT 307.

The powers pₖ are then truncated according to a threshold T which is set up with respect to the current power estimate, e.g. T=P₀+3 dB=2P₀ at first iteration and T=Pᵢ+3 dB=2Pᵢ after.

If pₖ≧T, then pₖ=T and if pₖ<T, then pₖ=pₖ.

After truncation and an average of the truncated powers, a correction coefficient is applied to the average, the correction assumes that the symbols the powers of which are truncated follow a complex Gaussian law.

The value after correction corresponds to the new power estimate, Pᵢ for the i^{th} iteration.

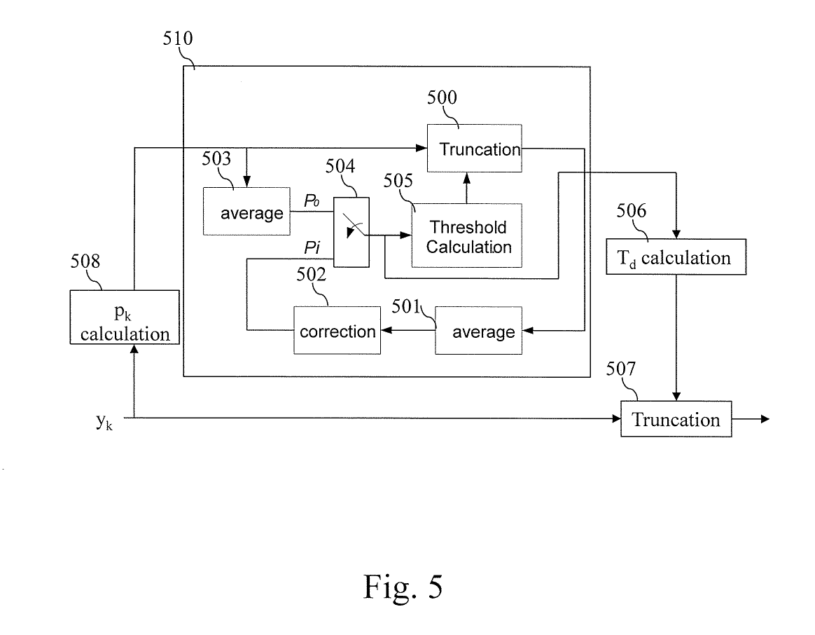

An example of the above mentioned estimation is given in reference to FIG. 5.

FIG. 5 discloses a block diagram of components of the adaptive threshold determination and truncation module according to the present invention.

The adaptive threshold determination and truncation module 305 comprises a frequency dependent received power module 508 which determines the frequency-dependent received power pₖ.

The present invention may be implemented on a block basis, i.e. by using

pₖ=|yₖ|²

The adaptive threshold determination and truncation module 305 comprises an adaptive signal and thermal noise power determination module 510.

The adaptive signal and thermal noise power module 510 comprises an averaging module 503 which averages the total received power Pₜ in order to calculate P₀:

$${P}_{0} = {P}_{t} = \frac{1}{M} {\sum }_{k} {p}_{k} .$$

The power P₀ is provided to a switch 504 which provides at the first iteration the power P₀, and once the first iteration is executed, a power Pᵢ, where i=1 to I−1, I being the total number of iterations that the adaptive signal and thermal noise power determination module 510 executes. The threshold calculation module 505 determines a first threshold value which is for example equal to T₀=2P₀ and at following iterations determines a threshold Tᵢ=2Pᵢ.

The threshold value T₀ and at following iterations Tᵢ are provided to a threshold application module 500 which truncates all signal powers which are upper than the threshold T₀ and at following iterations Tᵢ as follows:

if pₖ>Tᵢ then pₖ=Tᵢ.

otherwise pₖ value is not modified.

The power values are provided to an averaging module 501 which averages the power values provided by the threshold application module 500.

The average value provided by the averaging module 501 is then provided to a correction module 502 which determines and applies a correction coefficient δᵢ.

The correction coefficient δ₀ and at following iterations δᵢ is applied to compensate for the power loss generated by the truncation of at least one power to the thresholds T₀ and Tᵢ.

The calculation of the correction coefficient assumes that the signal the power of which is truncated is complex Gaussian.

For the i-th iteration, with i=0 to I−1 the correction coefficient δᵢ is determined as follows.

If a signal is complex Gaussian of power Pi, then its power follows an exponential law of probability:

p(x)=λᵢe^{-λ}^{ᵢ}^{x}

With parameter

$${λ}_{i} = \frac{1}{{P}_{i}}$$

If the threshold Tᵢ is applied to the power of such a signal, then the average power decreases and the average output power P_{AVi} is equal to:

$${P}_{AVi} = {\int }_{0}^{{T}_{i}} {xp}_{i} ( x ) d x + {T}_{i} {\int }_{{T}_{i}}^{∞} {p}_{i} ( x ) d x ⇒ {P}_{AVi} = {λ}_{i} {\int }_{0}^{{T}_{i}} x {e}^{- {λ}_{i} x} d x + {λ}_{i} {T}_{i} {\int }_{{T}_{i}}^{∞} {e}^{- {λ}_{i} x} d x ⇒ {P}_{AVi} = {λ}_{i} \{ {[ - \frac{1}{{λ}_{i}} x {e}^{- {λ}_{i} x} ]}_{0}^{{T}_{i}} + \frac{1}{{λ}_{i}} {\int }_{0}^{{T}_{i}} {e}^{- {λ}_{i} x} d x \} + {λ}_{i} {T}_{i} {\vert - \frac{1}{{λ}_{i}} {e}^{- {λ}_{i} x} \vert}_{{T}_{i}}^{∞} ⇒ {P}_{AVi} = - {T}_{i} {e}^{- {λ}_{i} {T}_{i}} + {[ - \frac{1}{{λ}_{i}} {e}^{- {λ}_{i} x} ]}_{0}^{{T}_{i}} + {T}_{i} {e}^{- {λ}_{i} {T}_{i}} = \frac{1}{{λ}_{i}} - \frac{1}{{λ}_{i}} {e}^{- {λ}_{i} {T}_{i}}$$

And therefore

$${P}_{AVi} = \frac{1}{{λ}_{i}} ( 1 - {e}^{- {λ}_{i} {T}_{i}} )$$

It can be expressed with respect to Pᵢ:

$${P}_{AVi} = {P}_{i} ( 1 - {e}^{- {T}_{i} / {P}_{i}} )$$

The multiplicative corrective term is equal to:

$${δ}_{i} = \frac{{P}_{i}}{{P}_{AVi}} = \frac{1}{1 - {e}^{- {T}_{i} / {P}_{i}}}$$

As P_{AVi} and Tᵢ are known, Pᵢ is derived by solving equation

$${P}_{AVi} = {P}_{i} ( 1 - {e}^{- {T}_{i} / {P}_{i}} )$$

for example by applying the fixed-point theorem.

According to a preferred mode of realization of the present invention, a look-up table is used for the calculation of δₜ or directly Pᵢ from P_{AVi} and Tᵢ. In this mode of realization, the above formulas are used to fill in the look-up table.

The corrected signal power is provided to the switching module 504, which provides it to the threshold calculation module 505 instead of the power P₀.

For example, the number of iterations may be equal to three to five.

At last iteration the power Pₛ is equal to the power Pᵢ determined at last iteration and the threshold T_{d} is determined by a threshold calculation module 506 as equal, for example to the power Pₛ determined at last iteration plus four dB.

The threshold T_{d} is provided to a data truncation module 507 which truncates the amplitudes of the received symbols in the frequency domain according to the following rule:

yₖ=ρₖe^{iφ}^{ₖ} if ρ²ₖ<T_{d}

yₖ=\sqrt{T_{d}}e^{iφ}^{ₖ} if ρₖ²≧T_{d}

where i is the square root of ‘−1’ in both above mentioned formulas.

The received symbols processed by the data truncation module 507 are then provided to the channel estimation module 302 and to the equalization module 306.

FIG. 6 discloses an example of an algorithm executed by a destination according to the present invention.

The present algorithm is more precisely executed by the processor 200 of the receiver Rec.

At step S600, the processor 200 commands the synchronisation module 301 to synchronise the DFT module 300 on the received symbols. The received symbols are obtained by transforming the received single carrier signal into received symbols.

At next step S601, the processor 200 commands the DFT module 300 to transform the received symbols from the time domain to the frequency domain into received symbols in the frequency domain yₖ where k denotes the index of subcarrier.

The received symbols in the frequency domain may be represented by:

yₖ=hₖxₖ+υₖ

At next step S602, the received symbols in the frequency domain are provided to the adaptive threshold determination and truncation module 305 and more precisely to the frequency dependent received power module 508 which determines the frequency-dependent received power pₖ. The present invention may be implemented on a block basis, i.e. by using

pₖ=|yₖ|²

At next step S603, the determined powers are provided to the adaptive signal and thermal noise power determination module 510 which performs an adaptive signal and thermal noise power determination as disclosed in reference to FIG. 5 in order to provide the signal and thermal noise power Pₛ estimate.

At next step S604, the threshold T_{d} is determined as equal, for example to the signal and thermal noise power Pₛ plus four dB. The threshold T_{d} is then used for truncating the amplitudes of the received symbols in the frequency domain according to the following formula:

yₖ=ρₖe^{iφ}^{ₖ} if ρ²ₖ<T_{d}

yₖ=\sqrt{T_{d}}e^{iφ}^{ₖ} if ρₖ²≧T_{d}

where i is the square root of ‘−1’ in both above mentioned formulas.

At next step S606, the truncated received symbols are provided to the channel estimation module 302 which performs a channel estimation.

At step S605, the processor 200 commands the noise plus interference power estimation module 303 to estimate the frequency dependent noise plus interference powers σₖ².

The noise plus interference power estimation module 303 uses the received symbols in the frequency domain or according to a variant uses the truncated received symbols in order to perform the frequency dependent noise plus interference power estimation.

At next step S607, the processor 200 commands the equalization. The equalization is performed using the channel estimates provided at step S606, possibly the frequency dependent noise plus interference power estimation provided at step S605 and the symbols outputted at step S604.

The equalization equalizes in the frequency domain. For example the equalization is a MMSE equalization and provides samples expressed by:

$${z}_{k} = \frac{{h}_{k}^{*}}{{\vert {h}_{k} \vert}^{2} + {σ}_{k}^{2}} {y}_{k} .$$

At next step S608, an IDFT transform is performed on samples provided by the equalization step S607.

Naturally, many modifications can be made to the embodiments of the invention described above without departing from the scope of the present invention.

1. Method for cancelling a narrow band interference in a single carrier signal, wherein the method comprises the steps executed by a receiver of:
receiving the single carrier signal and transforming the single carrier signal into received symbols,
transforming the received symbols from the time domain to the frequency domain into received symbols in the frequency domain,
determining a threshold based on the received symbols in the frequency domain,
truncating the amplitudes of the received symbols in the frequency domain at the determined threshold,
performing a channel estimation based on the truncated received symbols in the frequency domain.

2. Method according to claim 1, wherein the method comprises further steps of:
estimating the frequency-dependent received powers of received symbols in the frequency domain,
determining iteratively an adaptive signal and thermal noise power from the estimated frequency dependent receive powers,
determining the threshold truncating the received symbols in the frequency domain from the adaptive signal and thermal noise power determined at the last iteration.

3. Method according to claim 1, wherein the adaptive signal and thermal noise power iteratively determined is determined by:
executing a first averaging of the total received powers of the received symbols in the frequency domain,
determining, at a first iteration, a threshold based on the averaged total received power,
truncating all powers of the received symbols in the frequency domain which are upper than the determined threshold at the first iteration,
executing a second averaging of the truncated powers,
correcting the second average by a correction coefficient,
determining at a following iteration a following adaptive threshold based on the corrected average,
truncating all powers which are upper than the following adaptive threshold,
executing a third averaging of the truncated or not powers,
correcting the third average by a correction coefficient,
and executing a predetermined number of times, the adaptive threshold determination, the truncating, the third averaging and the correcting.

4. Method according to claim 3, wherein the correction coefficients are calculated assuming that the symbols the powers of which are truncated follow a complex Gaussian law.

5. Method according to claim 4, wherein the coefficients are determined using a lookup table.

6. Method according to claim 1, wherein the single carrier signal is a single carrier orthogonal frequency division multiplex modulation signal.

7. Method according to claim 1, wherein the method further comprises the steps of:
performing a frequency dependent noise plus interference power estimation based on the received symbols transformed from the time domain to the frequency domain into received symbols in the frequency domain or based on the truncated received symbols in the frequency domain.

8. Method according to claim 6, wherein the method comprises further step of performing a minimum mean square error equalization based on the channel estimation, based on the truncated received symbols in the frequency domain and based on the frequency dependent noise plus interference power estimation.

9. Device for cancelling a narrow band interference in a single carrier signal, wherein the device is included in a receiver and comprises:
means for receiving the single carrier signal and transforming the single carrier signal into received symbols,
means for transforming the received symbols from the time domain to the frequency domain into received symbols in the frequency domain,
means for determining a threshold based on the received symbols in the frequency domain,
means for truncating the amplitudes of the received symbols in the frequency domain at the determined threshold,
means for performing a channel estimation based on the truncated received symbols in the frequency domain.

10. Computer program which can be directly loadable into a programmable device, comprising instructions or portions of code for implementing the steps of the method according to claim 1, when said computer program is executed on a programmable device.
